(19) United States
(12) Patent Application Publication
(10) Pub. No.: US 2009/0309464 A1
(43) Pub. Date: Dec. 17, 2009

(54) FURNITURE ASSEMBLY SYSTEM AND FURNITURE INCORPORATING SUCH SYSTEM

(75) Inventor: DAVID L. SCHWARTZ, Creve Coeur, MO (US)

Correspondence Address: ERICKSON, KERNELL, DERUSSEAU & KLEYPAS, LLC, 800 W. 47TH STREET, SUITE 401, KANSAS CITY, MO, 64112, US

(73) Assignee: AMERIWOOD INDUSTRIES

(21) Appl. No.: 12/138,177

(22) Filed: Jun. 12, 2008

(51) Int. Cl. A47B 87/00; F16B 12/00

(52) U.S. Cl. 312/111; 312/107

(57) ABSTRACT

Ready-to-assemble furniture requiring no tools for assembly includes horizontal and vertical members arranged in an interlocking configuration and a back member fastened to the horizontal and vertical members. The furniture assembly system may be configured with one or more cubes and may be free-standing or hung on a wall. Containers may be provided sized to fit with the cubes and one or more furniture assembly systems may be attached together.

### BACKGROUND

The present invention relates to ready-to-assemble furniture and, more particularly, to an assembly system for ready-to-assemble furniture requiring no tools to assemble such furniture.

Ready-to-assemble (“RTA”) furniture such as bookcases, storage shelves and bins, utility cabinets and chests of drawers are typically panel-constructed products that are stored and shipped flat. RTA furniture is typically assembled on site with the aid of a screw driver or other such tool. The panels are held together by a cooperating combination of connecting bolts and cams which are manipulated by use of the screw driver to hold the panels together and form the furniture. This assembly system requires a level of mechanical aptitude that may not be consistently present in the general public or among consumers of RTA furniture. Additionally, consumers of RTA furniture may not own the tools necessary for assembly.

### SUMMARY

The present invention provides a furniture assembly system that may be utilized with RTA furniture which requires no tools for assembly. The assembled furniture may include bookcases, closet storage, generally storage, utility cabinets, and chests of drawers, for example. The RTA furniture includes horizontal and vertical interlocking panels and may include back panels with locking clips to provide stability to the system and to lock the horizontal and vertical panels in place. Corner, intersecting and stacking clips may be used to fasten the system together and to combine one or more systems.

### BRIEF DESCRIPTION OF THE DRAWINGS

FIG. 1 is a front elevational view of an embodiment of the present invention.

FIG. 2 is a side elevational view of FIG. 1.

FIG. 3 is an exploded perspective view of FIG. 1 with the fasteners not shown.

FIG. 4 is a perspective view of two units of FIG. 1 shown stacked and an enlarged H-style extension.

FIG. 5 is a perspective view of two units of FIG. 1 side by side and the H-style extensions of FIG. 4.

FIGS. 6A and 6B include front and back enlarged perspective views of alternate back panels.

FIG. 7 is an enlarged perspective view of a corner clip.

FIG. 8 is an enlarged perspective view of a four-way clip.

FIG. 9 is an enlarged perspective view of a stacking clip.

FIG. 10 is an enlarged perspective view of a T-shaped clip.

FIG. 11 is an enlarged perspective view of an alternate back panel and retaining clip.

FIG. 12 is a perspective partially exploded view of the present invention shown with drawers and an optional top.

### DETAILED DESCRIPTION

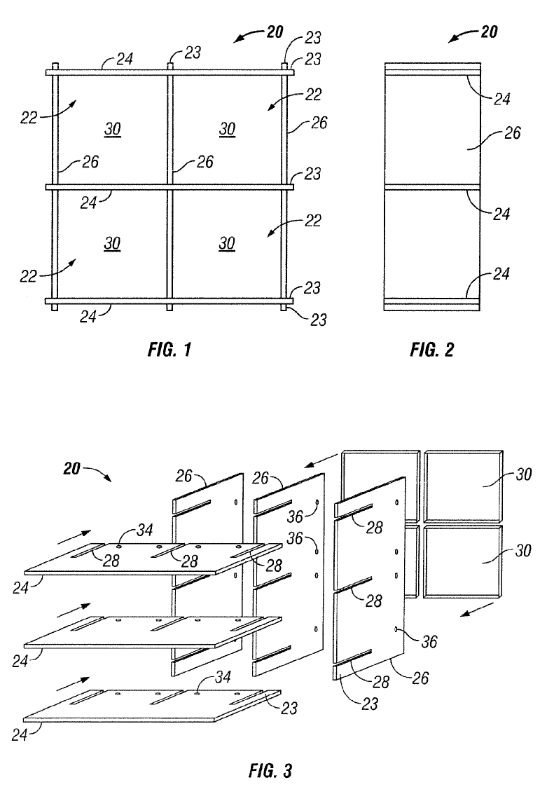

Referring initially to FIGS. 1-3, a furniture assembly system for ready-to-assemble furniture is generally indicated by reference numeral 20. As shown in FIG. 1, RTA furniture 20 is assembled to form four storage cubes 22. The RTA furniture 20 is assembled without any tools and includes three horizontal members 24 and three vertical members 26. Each member 24 and 26 includes three slots 28 which extend laterally to a midway point within the member. The width of the slots 28 matches the thickness of the members. The location of the slots 28 is spaced to present even intervals between the slots 28. When the slots 28 of the horizontal 24 and vertical 26 members are engaged, the members form a series of interlocked cubes 22 with tabs 23 extending from the periphery of the unit 10 such that an observer may see through the cubes 22 or an optional back member 30 may be secured to the rear of one or more cubes 22.

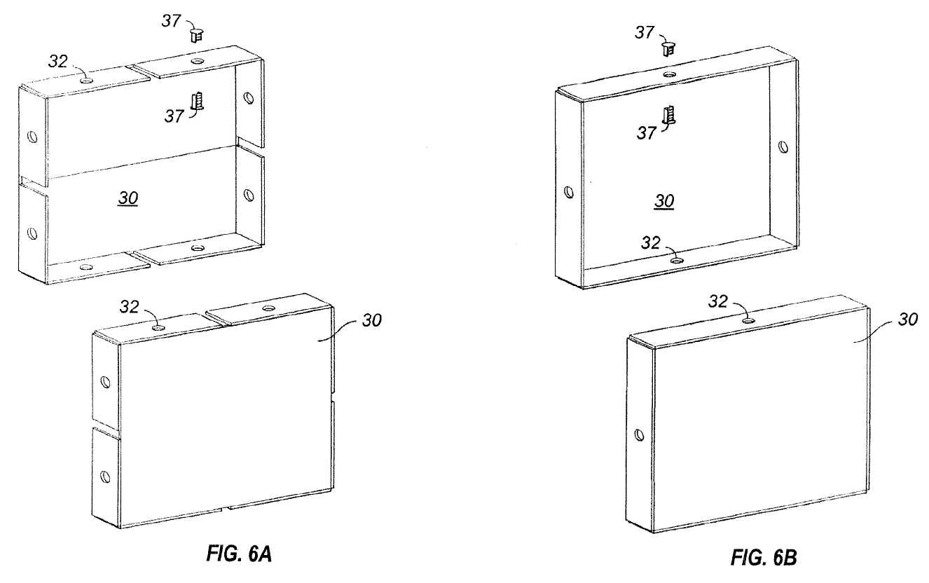

The back member 30 (see FIG. 6) includes mounting holes 32 which align with holes 34 in the horizontal members 24 and holes 36 in the vertical members 26 or the RTA furniture 20. Press-together fasteners 38 such as TRW fasteners may be placed through the holes to secure the back member 30 in place. The back members 30 provide a pleasing aesthetic appearance to the RTA furniture 20, hide wires or other cords extending from electronics that may be placed on the top surface from view, and provide additional structural integrity for the RTA furniture 20. As shown in FIGS. 3 and 6A, the back members 30 include two holes 32 in each tab, and a back member 30 is installed in each cube 22. As shown in FIG. 6B, the back member 30 includes one hole 32 in each tab. It should be understood that the back member 30 may include one, two, or more holes in each tab depending on the size and use of the RTA furniture 20. Additionally, RTA furniture 20 may be assembled with or without back members 30, or with a combination of back members 30 in some cubes 22 and not in others.

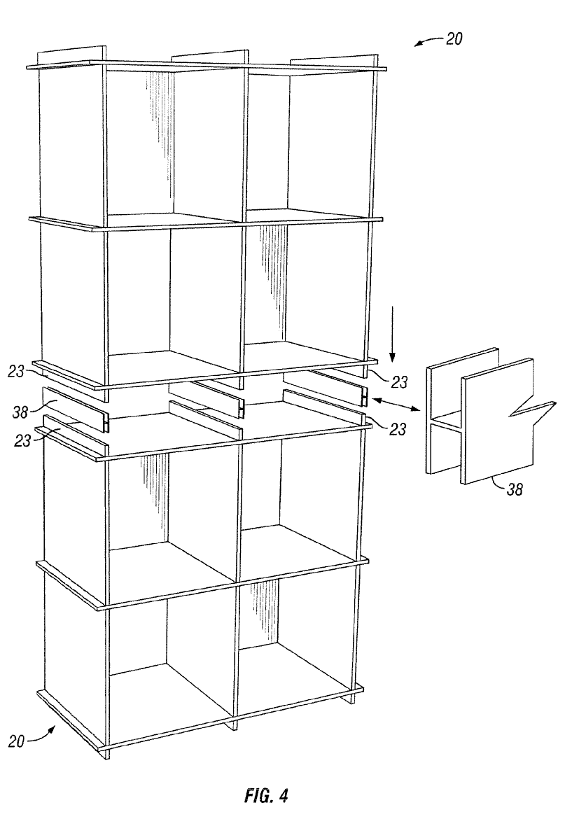

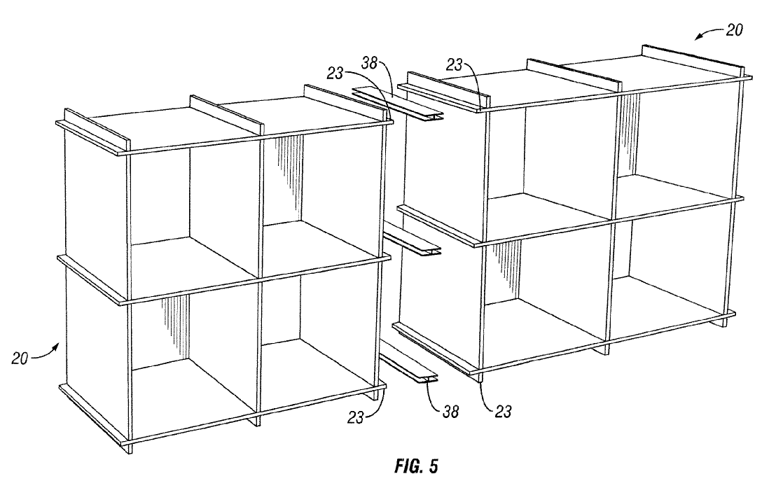

Referring to FIGS. 4 and 5, two RTA furniture units 20 may be stacked (FIG. 4) or placed side by side (FIG. 5) and secured together using H-style extrusions or clips 38. The extrusions 38 slide over the tabs 23 on both the upper and lower unit to lock the units together. Likewise, the extrusions 38 slide over the tabs 23 on the adjacent side-by-side units to secure the units together. In this way a plurality of units may be stacked and connected side by side as desired.

Referring to FIG. 7 a clip 50 is shown to provide structural strength to the unit assembly 20. Clip 50 includes a U-shaped channel member 52. One arm 54 of the U-shaped channel includes a lip 56 extending into the channel 52. The lip 56 is adapted to engage grooves 58 spaced away from the edge 60 of the horizontal 24 and vertical 26 members. The other arm 55 of the U-shaped channel 52 may include a rounded edge to make it easier to push the clip 50 over the edge 60 of the horizontal 24 and vertical 26 members. Clip 50 is pushed onto intersecting members until the lip 56 snaps into the groove 58. Clip 50 may be used along the outside intersections of the members 24 and 26. Clip 50 also includes a web 62 between a horizontal and vertical channel, which provides additional structural stiffness to the unit 20.

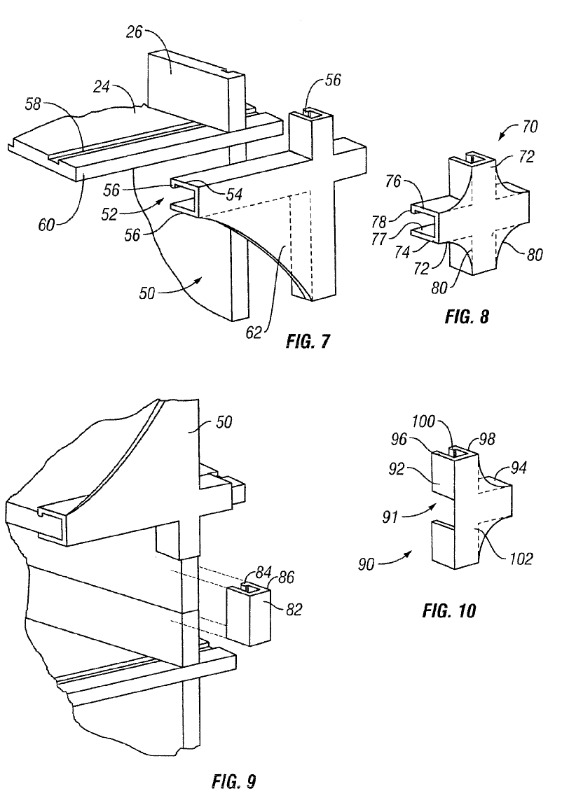

A four-way clip 70 is illustrated in FIG. 8. Four-way clip 70 includes four symmetrical legs 72. Each leg 72 is a U-shaped channel member 74 with one arm 76 including a lip 78 extending into the channel 74. The lip 78 is adapted to engage grooves 58 as described hereinabove. The four-way clip 70 also includes webs 80 extending between the legs 72. The clip 70 may be used at the intersections of horizontal 24 and vertical 26 panel members.

A stacking clip 82 is illustrated in FIG. 9. Stacking clip 82 is a U-shaped channel with a lip 84 extending from one arm 86. The stacking clip 82 is used to connect the tabs 23 of two or more units 20. Stacking clip 82 may be used in conjunction with or in place of the H-style extrusions 38 (FIGS. 4 and 5).

A T-shaped clip 90 is illustrated in FIG. 10. T-shaped clip 90 includes one long leg 92 and a short leg 94 extending perpendicularly from the long leg 92. Each leg is a U-shaped channel member 96 with one arm 98 including a lip 100 extending into the channel 96. The lip 100 is adapted to engage grooves 58 as described hereinabove. The T-shaped clip 90 includes webs 102 extending between the legs 92 and 94 to provide additional strength to the clip.

Preferably the clips 50, 70, 82 and 90 as well as extrusion 38 are plastic, although other materials such as aluminum may be used. In the preferred embodiment, clips 50, 70 and 90 are used with configurations not including a back member 30. However, adaptations of the back member 30 and/or clips 50, 70 and 90 may be made to be used in combination and are within the scope of the present invention.

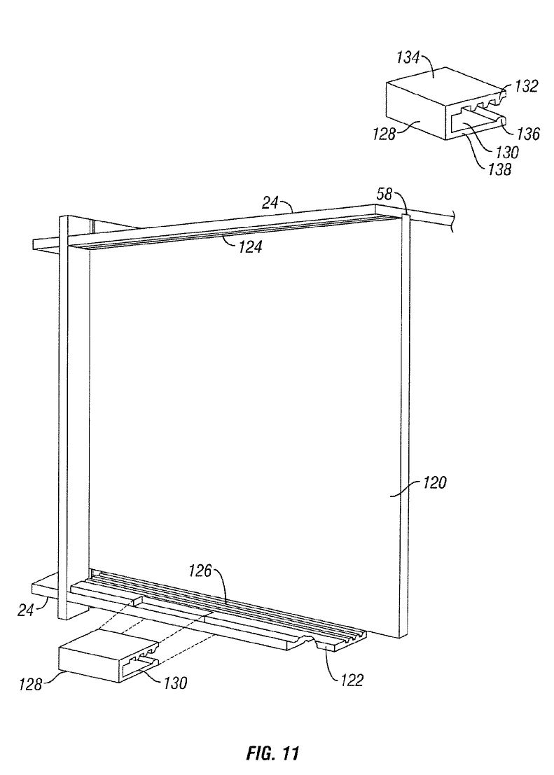

Referring to FIG. 11, an alternative attachment for a back 120 is illustrated. Back 120 is generally square with a tab 123 extending from one of the sides. The upper edge 124 of the back 120 fits into a groove 58 of the upper horizontal panel member 24. The tab 122 includes one or more locking grooves 126 and folds perpendicularly to the back 120 to lie flat against the lower horizontal panel members 24. A locking clip 128 includes a U-shaped channel 130 with locking teeth 132 extending longitudinally along the inner surface of one of the arms 134 of the channel 130. A lip 136 extends from the inner surface of the other arm 138 of the channel 130. The locking clip 128 is forced over the top 122 and lower horizontal panel member 24. The locking teeth 132 mate with the locking grooves 126 in the tab 122. The lip 136 of the locking clip 128 engages the groove 58 in the lower surface of the lower horizontal member panel 24 to lock the clip 128 and back panel 128 in place. Tab 122 may include a notch 140 to place the locking clip 128.

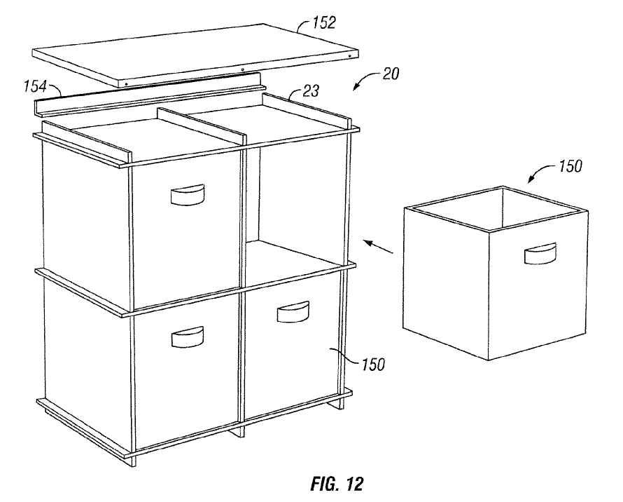

Referring to FIG. 12, RTA furniture 20 is illustrated with baskets or drawers 150, which are sized to fit into storage cubes 22. The drawers 150 freely side into and out of the cubes 22. An optional top 152 and back 154 may be attached to the upper tabs 23 of the RTA furniture 20 using fasteners (not shown) that do not require tools to apply.

RTA furniture 20 may be free-standing or may be hung on a wall. As illustrated in the figures, the number of cubes 22 in the RTA furniture 20 is four per unit and the cube shape illustrated is a square. However, it should be understood that this is for illustration and discussion purposes only. The size, shape, and number of cubes 22 in a unit 20 may vary along with the overall shape and configuration of the unit 20. For example, the unit 20 may have a two by three cube configuration with all cubes 22 symmetrical, a one by six cube configuration with the cubes 22 having a rectangular shape, or a combination of squares and rectangles, for example. The unit 20 may be configured in an L-shape with two horizontal and three vertical cubes 22.

Those skilled in the art will recognize that the RTA furniture unit 20 as described herein may be assembled entirely without tools. Other and further uses of the invention in its most general form will be clear to those skilled in the art after perusal of the application, and are within the scope and spirit of the invention.

Although preferred embodiments are disclosed herein, many variations are possible which remain within the concept, scope and spirit of the invention, and these variations would become clear to those skilled in the art upon examination of this application.

Having thus described the invention, what is claimed as new and desired to be secured by Letters Patent is as follows:

1. A furniture assembly system comprising:
a pair of first members each having a rectangular shape, a pair of slots extending from a first edge to a midpoint of said first member, said slots generally perpendicular to said first edge, and an aperture proximal a second edge opposite said first edge,
a pair of second members each having a rectangular shape, a pair of slots extending from a first edge to a midpoint of said second member, said slots generally perpendicular to said first edge, and an aperture proximal said first edge,
said pair of first members arranged in a vertical spaced-apart configuration;
said pair of second members arranged in a horizontal spaced-apart configuration;
said slots of said first members engaged with said slots of said second members to form an open cube whereby said second edge of said first members is coplanar with said first edge of said second members;
a back member having a rectangular shape and tabs extending from each edge, said back member adapted to fit within said open cube, each of said tabs having an aperture for alignment with said apertures of said first and second members; and
a plurality of fasteners, one of each passing through said apertures of said tabs and said apertures of said first and second members to secure said back member to said first and second members;
whereas said furniture assembly system is assembled without the aid of tools.

2. The furniture assembly system of claim 1 further comprising a plurality of first and second members having a plurality of aligned slots assembled to form a plurality of open cubes, and one or more back members fastened within one or more of said open cubes.

3. The furniture assembly system of claim 1 further comprising a container adapted to fit within said open cube.

4. The furniture assembly system of claim 1 further comprising a clip adapted to secure two furniture assembly systems together.

5. A furniture assembly system comprising:
a pair of first members each having a rectangular shape, a pair of slots extending from a first edge to a midpoint of said first member, said slots generally perpendicular to said first edge, and a groove in a first surface generally parallel to a second edge opposite said first edge,
a pair of second members each having a rectangular shape, a pair of slots extending from a first edge to a midpoint of said second member, said slots generally perpendicular to said first edge, and a groove in a first surface generally parallel to said first edge,
said pair of first members arranged in a vertical spaced-apart parallel configuration with said first surfaces facing toward each other;
said pair of second members arranged in a horizontal spaced-apart parallel configuration with said first surfaces facing in the same direction;
said slots of said first members engaged with said slots of said second members to form an open cube whereby said second edge of said first members is coplanar with said first edge of said second members;
a back member having a rectangular shape and a tab extending perpendicularly from a first edge, said back member adapted to fit within said grooves of said first surfaces, said tab having a locking groove generally parallel to said first edge of said back member; and
a U-shaped locking clip having a channel, a first arm having one or more locking teeth extending into said channel and a second arm having a lip extending into said channel opposite said one or more locking teeth, said locking teeth engaging said locking groove of said tab of said back member, said lip engaging said groove in said first surface of one of said second members;
whereas said furniture assembly system is assembled without the aid of tools.

6. The furniture assembly system of claim 5 further comprising a plurality of first and second members having a plurality of aligned slots assembled to form a plurality of open cubes, and one or more back members fastened within one or more of said open cubes.

7. The furniture assembly system of claim 5 further comprising a container adapted to fit within said open cube.

8. The furniture assembly system of claim 5 further comprising an H-shaped clip adapted to secure two furniture assembly systems together.

9. The furniture assembly system of claim 5 further comprising a corner clip adapted to engage said first and second members at an intersection between said first and second members, said corner clip having an at least one lip adapted to engage at least one groove in said first surface of said first or second member.

10. The furniture assembly system of claim 5 further comprising a T-shaped clip adapted to engage said first and second members at an intersection between said first and second members, said F-shaped clip having an at least one lip adapted to engage at least one groove in said first surface of said first or second member.
